(19) United States
(12) Patent Application Publication
(10) Pub. No.: US 2010/0313133 A1
(43) Pub. Date: Dec. 9, 2010

(54) AUDIO AND POSITION CONTROL OF USER INTERFACE

(75) Inventors: Adam Green, Redmond, WA (US); Robert Matthew Craig, Bellevue, WA (US); Dennis Tom, Redmond, WA (US); Jeffrey Ma, Kirkland, WA (US); Erik Arthur, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/480,430

(22) Filed: Jun. 8, 2009

(51) Int. Cl. G06F 3/16

(52) U.S. Cl. 715/728

(57) ABSTRACT

A method is provided for using a wireless controller to interact with a user interface presented on a display. The method includes receiving an audio signal and a position signal from the wireless controller. The audio signal is based on an audio input applied to the wireless controller, while the position signal is based on a position input applied to the wireless controller. The method includes selecting a user interface item displayed on the display, based on the audio signal and the position signal. One or more position signals from the wireless controller may also be received and processed to cause navigation of the user interface to highlight a user interface item for selection.

### BACKGROUND

A user may interact with a computing device via an input device such as a game controller, computer mouse, keyboard, etc. which provides data and control signals to the computing device. Such a computing device and input device may be part of a computing system including a display device that displays a user interface of selectable items. A user may then use the input device to navigate through the items and select a particular item of interest. In some cases, the input device may communicate wirelessly to provide interaction with the user interface.

### SUMMARY

Accordingly, the present disclosure provides a method of using a wireless controller to interact with a user interface presented on a display. The method includes receiving an audio signal from the wireless controller based on an audio input applied to the wireless controller, and receiving a position signal from the wireless controller based on a position input applied to the wireless controller. Based on the audio signal and the position signal, a selection command is recognized which causes selection of a user interface item on the display. In addition to selection of the user interface item, a position signal or position signals from the wireless controller may be used to navigate the user interface to highlight a user interface item for selection.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of a computing system, including an exemplary wireless controller for navigating and selecting user interface items.

FIG. 2 shows a flow diagram of an embodiment of a method of navigating a user interface via a wireless controller.

FIG. 3 schematically shows an embodiment of a signal from a wireless controller which may be interpreted to generate a navigation command for navigating a user interface.

FIG. 4 illustrates an example relationship between various statically-held positions of a wireless controller and resulting z-axis components of gravitational acceleration, as detected by an accelerometer of the wireless controller.

FIGS. 5 and 6 illustrate example ranges of angular positions of a wireless controller, which may be interpreted to generate navigation commands for navigating a user interface.

FIG. 7 shows a flow diagram of an embodiment of a method of selecting a user interface item via a wireless controller.

FIG. 8 illustrates an example of two signals which may be interpreted to generate a selection command for selecting an item on a user interface.

### DETAILED DESCRIPTION

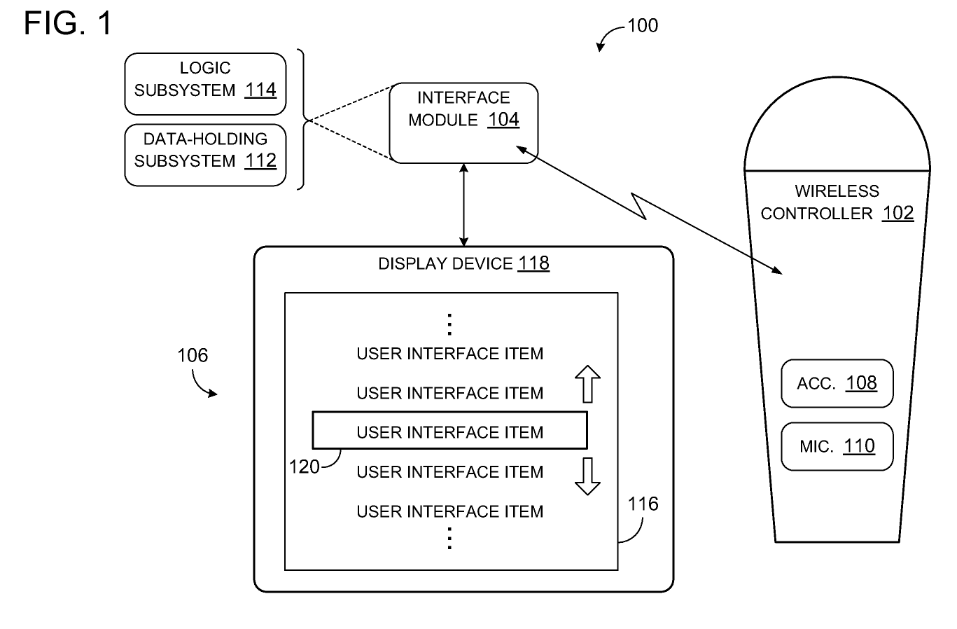

FIG. 1 shows a computing system 100 including a wireless controller 102, an interface module 104 and a display subsystem 106. Interface module 104 is operatively coupled with the wireless controller and the display subsystem. Wireless controller 102 may include an accelerometer 108 configured to detect acceleration and/or position of wireless controller 102. For example, accelerometer 108 may detect various inputs applied to the wireless controller which may be interpreted or processed to determine positioning of wireless controller 102, thus such inputs may be referred to herein as position inputs. In some cases accelerometer 108 may be a three-axis accelerometer configured to detect values indicating movement in any of three orthogonal coordinate directions. In such a case, position inputs applied to the wireless controller may include any inputs resulting in an acceleration applied to the controller (i.e., a change in velocity over time). As nonlimiting examples, such inputs may include a force, impulse or other such motion applied to the controller. In another case, position inputs may include motion applied to change the orientation (roll, pitch, tilt, yaw, etc.) of the controller, since this affects the z-axis component (axial to the controller) of gravitational acceleration. From these detected position inputs, the data may be interpreted (e.g., via an algorithm) to determine the controller's position, velocity, acceleration, etc.

Wireless controller 102 may also include a microphone 110 configured to detect audio inputs such as a user's voice, hand clapping, finger snapping, or any other type of audio input.

In response to position inputs and audio inputs applied to wireless controller 102, the wireless controller may output and transmit corresponding signals to interface module 104. For example, in some embodiments, wireless controller 102 may be configured, based on the applied position inputs, to output position signals (e.g., a stream of positional data signals) to interface module 104. Likewise, wireless controller 102 may be configured, in response to the applied audio inputs, to output audio signals (e.g., a stream of audio signals) for receipt by interface module 104. Wireless controller 102 may be configured to transmit these signal streams to interface module 104 via a wireless local area network, a Bluetooth connection or any other wireless link which is appropriate to a given setting. Wireless controller 102 may further include a multicolor LED or other output configured to be software-controlled. Accordingly, in such a case, wireless controller 102 may be further configured to receive one or more signals from interface module 104 to illuminate the LED or otherwise provide an output.

In some embodiments, wireless controller 102 may have a form factor of a handheld microphone such as, for example, a vocal microphone. As will be described in various examples, the audio and accelerometer outputs of the controller may be employed to generate commands to control a user interface, via interaction with interface module 104. Furthermore, the user interface functionality may be achieved without additional buttons, actuators, etc. on the wireless controller. This may be desirable in some cases to preserve a desired form factor or aesthetic for the wireless controller, for example so that it appears to be a “real” microphone of the type used in audio recording and performance.

Interface module 104 may be implemented via executable instructions such as instructions on a data-holding subsystem 112 that are executable by a logic subsystem 114. Data-holding subsystem 112 may be any suitable computer readable medium, such as a hard drive, optical drive, memory chip, etc. Further, in some embodiments, data-holding subsystem 112 may be a removable computer readable medium such as a memory card, CD, DVD and the like.

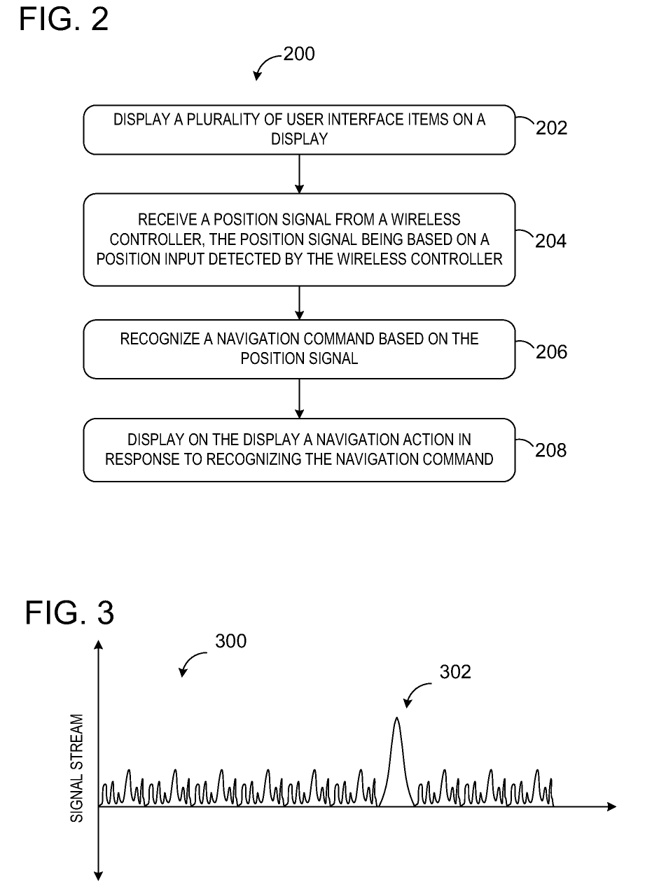

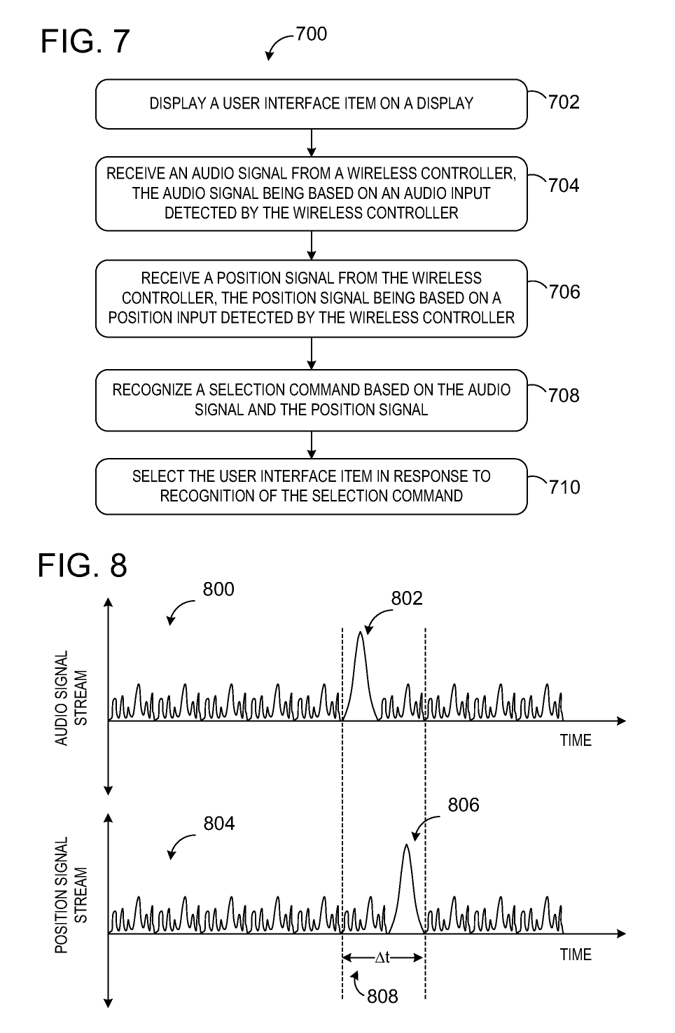

As described in more detail hereafter with reference to FIG. 2 and FIG. 7, the instructions instantiating interface module 104 may be executable to recognize navigation commands based on the position signals, and/or recognize selection commands based on a combined interpretation of the position signals and the audio signals. Thus, wireless controller 102 may operate as an input device for interacting with a user interface 116 displayed on a display device 118. User interface 116 may display user interface items that can be navigated (e.g., via scrolling to highlight specific items for selection) via the navigation commands produced by interface module 104 in response to signals from the wireless controller. In some cases, the user interface may include a selection indicator 120 which is positioned via scrolling or other navigation actions in response to the navigation commands. Once a particular item is highlighted or otherwise chosen for selection, the aforementioned selection commands may be used to perform the actual selection of the user interface item.

In some embodiments, the above mentioned computing system may include a video gaming system. In such a case, logic subsystem 114 may be included on a game-playing device, such as a video game console, which may be configured to execute instructions on data-holding subsystem 112 for instantiating interface module 104. Such instructions may also include game code for executing a music video game.

In the example setting of a music video game, wireless controller 102 may then be a gaming controller with the form factor of a handheld microphone for delivering an audio performance. The microphone would be configured to receive audio inputs (e.g., a user's vocal inputs) during game play. The above-described navigation commands and selection commands enable the wireless controller in this example to also function as an input device, enabling the user to navigate menus and select items displayed on the menus. As previously discussed, the navigation and selection commands may be achieved via audio and accelerometer signals without additional buttons, actuators, etc. Therefore, the wireless controller may maintain the form factor of a handheld microphone allowing for a more realistic gaming experience for the user.

When included in the present examples, a logic subsystem (e.g., logic subsystem 114) may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

When included in the present examples, a data-holding subsystem (e.g., data-holding subsystem 112) may include one or more physical devices configured to hold data and/or instructions executable by the logic subsystem to implement the herein described methods and processes. When such methods and processes are implemented, the state of data-holding subsystem may be transformed (e.g., to hold different data). The data-holding subsystem may include removable media and/or built-in devices. The data-holding subsystem may include optical memory devices, semiconductor memory devices, and/or magnetic memory devices, among others. The data-holding subsystem may include devices with one or more of the following characteristics: volatile, nonvolatile, dynamic, static, read/write, read-only, random access, sequential access, location addressable, file addressable, and content addressable. In some embodiments, a logic subsystem and data-holding subsystem may be integrated into one or more common devices, such as an application specific integrated circuit or a system on a chip. The data-holding subsystem may also be in the form of computer-readable removable media, which may be used to store and/or transfer data and/or instructions executable to implement the herein described methods and processes.

The terms “module” and “engine” may be used to describe an aspect of computing system 100 that is implemented to perform one or more particular functions. In some cases, such a module or engine may be instantiated via logic subsystem 114 executing instructions held by data-holding subsystem 112. It is to be understood that different modules and/or engines may be instantiated from the same application, code block, object, routine, and/or function. Likewise, the same module and/or engine may be instantiated by different applications, code blocks, objects, routines, and/or functions in some cases.

When included, a display subsystem (e.g., display subsystem 106) may be used to present a visual representation of data held by a data-holding subsystem. As the herein described methods and processes change the data held by the data-holding subsystem, and thus transform the state of the data-holding subsystem, the state of the display subsystem may likewise be transformed to visually represent changes in the underlying data. The display subsystem may include one or more display devices utilizing virtually any type of technology. Such display devices may be combined with a logic subsystem (e.g., logic subsystem 114) and/or a data-holding subsystem (e.g., data-holding subsystem 112) in a shared enclosure, or such display devices may be peripheral display devices.

FIG. 2 shows a flow diagram of an embodiment of a method 200 of navigating a user interface via a wireless controller. An embodiment of such a method may include navigating of user interface 116 via wireless controller 102 as depicted in FIG. 1.

At 202, method 200 includes displaying a plurality of user interface items on a display. Typically, the user interface items are selectable items presented via a user interface. Examples of such user interface items may include, for example, menu items, contextual menu items, selectable options, etc. In the context of a gaming system, such user interface items may include game settings, character settings, audio settings, visual settings, or any other selectable item or option. It should be appreciated that these examples of user interface items are nonlimiting in that user interface items may include any other suitable user interface items as indicated by the instructions of the interface module. As previously discussed, the user interface items may be presented in a user interface, such as user interface 116, and may be displayed on a display, such as display device 118 (FIG. 1).

Returning to FIG. 2, at 204, method 200 may include receiving a position signal from a wireless controller. As described above, such a wireless controller may be wireless controller 102 as shown in FIG. 1. Further, such a position signal may be received from the wireless controller by an interface module over a wireless network, as described above with reference to FIG. 1. The position signal may be a peak, such as, for example, a peak within a stream of position data received from an accelerometer or other sensing mechanism of the wireless controller. Such a peak may be defined by any number of features, such as being localized from other data of the signal stream, being of a short duration, exhibiting a magnitude excursion with respect to the rest of the signal stream, and the like. As an example, FIG. 3 depicts a graph 300 of a signal stream including a signal 302. As will be explained in more detail, identifying a signal with particular characteristics may trigger an action with respect to a displayed user interface.

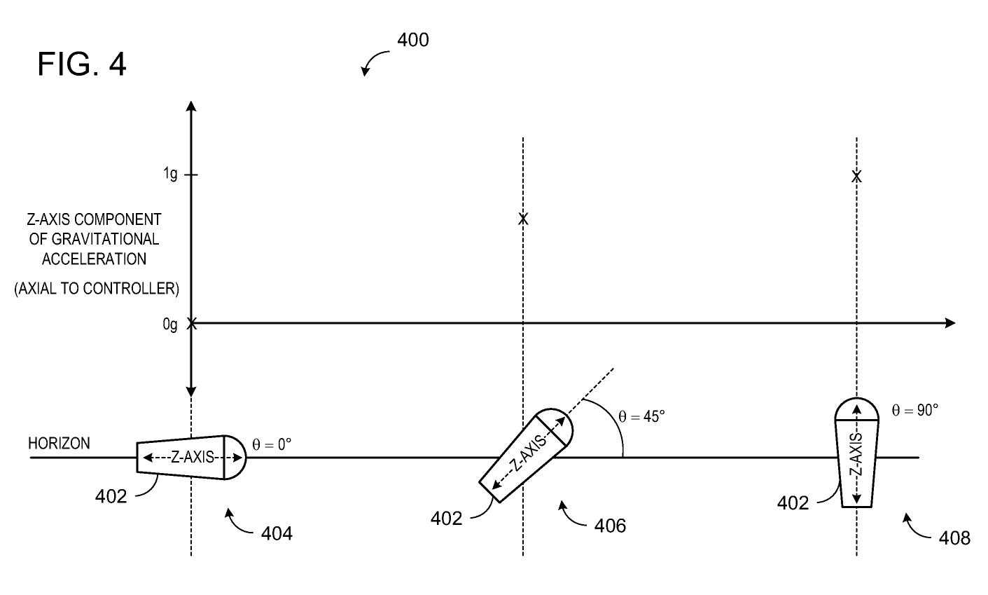

The position signal received at 204 is an output (e.g., from an accelerometer) based on a position input applied to the wireless controller (e.g., movement, tilting, etc. of the controller). The output may indicate, among other things, a positioning of the wireless controller at an angle. As an example, FIG. 4 shows, in the context of a wireless controller with an accelerometer, a graph 400 depicting a correlation between a detected z-axis component of gravitational acceleration of the wireless controller 402 and an angle of the wireless controller with respect to the horizon. As depicted, the z-axis of wireless controller 402 is defined as being in a substantially axial direction with respect to the elongate body of wireless controller 402. Although the total gravitational acceleration of the wireless controller while stationary may be of a constant magnitude and direction due to gravity, a vector component of this gravitational acceleration in a direction axial to the controller may change as the orientation of the controller changes, as described hereafter.

At 404, wireless controller 402 is depicted in a horizontal position, i.e., an angle of θ=0° where θ is measured with respect to the horizon. Accordingly, such positioning corresponds to a z-axis component of gravitational acceleration of 0 g, where g is one gravitational unit (e.g., near the surface of the Earth, 1 g≈32 ft/sec²). In other words, when the controller is in the horizontal position shown at 404, the gravitational acceleration along the axial direction of the controller body is zero. At 406, wireless controller 402 is depicted at an intermediate angle (e.g., θ=45°) with respect to the horizon and such positioning corresponds to a z-axis component of gravitational acceleration of some intermediate value between 0 g and 1.0 g. At 408, wireless controller 402 is depicted at an angle of θ=90° with respect to the horizon and such positioning corresponds to a z-axis component of gravitational acceleration of 1 g.

Returning to FIG. 2, at 206, method 200 next includes recognizing a navigation command based on the position signal. The navigation command corresponds to a navigation action that may be performed in relation to the user interface, such as moving a selection indicator “up,” “down,” “right,” “left,” etc. to highlight a selectable user interface item.

In some embodiments, a module such as interface module 104 described above with reference to FIG. 1 may perform the recognition of the navigation command. The navigation command may be recognized by any suitable approach. One such approach includes having predetermined correlations between position signals and navigation commands, such that upon receiving a particular position signal, the corresponding navigation command may be identified.

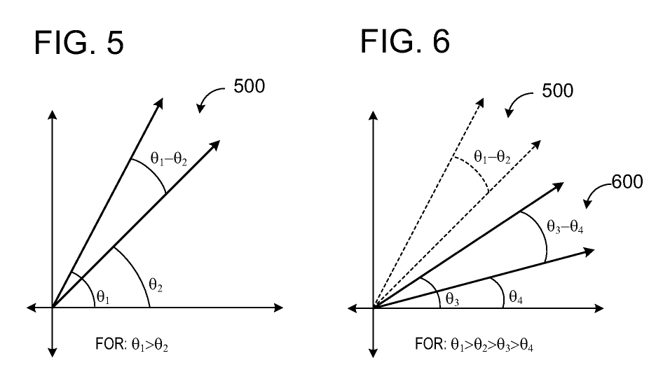

For example, in the case that the position signal indicates a positioning of the controller at an angle, a first range of angle values may be mapped to a particular navigation command, with a second range of angle values corresponding to another navigation command. As an example, FIG. 5 depicts a first range of angle values 500, between an angle θ₁ and another angle θ₂, where θ₁>θ₂. According, a position signal corresponding to an angle falling within this range may be recognized to correspond to, for example, an upward scrolling command. Similarly, FIG. 6 depicts a second range of angle values 600, between an angle θ₃ and another angle θ₄, where θ₁>θ₂>θ₃>θ₄. Accordingly, a position signal corresponding to an angle falling within this second range of angle values may be recognized to correspond to, for example, a downward scrolling command. In some embodiments, an angle recognized between these two ranges (e.g., an angle between θ₂ and θ₃) may correspond to a navigation command of no scrolling.

It will be appreciated that the angle ranges depicted in FIGS. 5 and 6 are shown as nonlimiting examples, and accordingly the angle ranges may be defined differently. For example a first range of angles may include all angles above the horizon, (e.g., 0>θ>90°) and the second range of angles may include all angles below the horizon, (e.g., 0>θ>−90°). As a modification of this example, a relatively small “dead zone” could be defined about the horizontal so that no scrolling would occur for small tilting angles.

Returning to FIG. 2, at 208, method 200 includes displaying on the display a navigation action in response to recognizing the navigation command. For example, in response to recognizing an upward scrolling command, a navigation action of upward scrolling may be displayed on the display. In some embodiments, the navigation action may be a horizontal scrolling operation (e.g., leftward or rightward) controlled in response to an accelerometer output or other position signal. Furthermore, navigation may occur in directions other than those of the described vertical and horizontal scrolling examples. Further, controllers having a three-axis accelerometer may indicate navigation commands not only corresponding to navigation actions such as horizontal and/or vertical scrolling of a two-dimensional user interface, but may further indicate commands for scrolling in an additional dimension. Accordingly, the navigation action moving a selection indicator may be used to navigate a one-dimensional, two-dimensional or three-dimensional user interface being displayed on the display.

Further, in some embodiments, the navigation command may also indicate how the navigation action may be displayed. For example, holding the controller at an angle for a given duration of time may not only indicate a navigation command of scrolling but may further indicate a speed at which to scroll.

Thus, in some embodiments, a computing system such as computing system 100 may be configured in accordance with method 200 to allow a user to interact with a displayed user interface simply by moving, tilting, rotating etc. a wireless controller. Thus, executing the instructions of method 200 can allow a wireless controller to be used for navigation instead of having to use additional buttons, actuators or a traditional directional pad, which may provide a more natural or otherwise improved user experience. For example, in a music video game, a user could easily navigate through a list of selectable items with the microphone being used for singing, simply by tilting/moving the microphone as described above.

In addition to navigation of a user interface, the present disclosure encompasses selection of user interface items based on position signals and audio signals from a wireless microphone or other wireless controller. In particular, FIG. 7 shows a flow diagram of an embodiment of a method 700 of selecting a user interface item via a wireless controller. An embodiment of such a method may include selection of user interface items of a user interface 116 via a wireless controller 102, as depicted in FIG. 1.

At 702, method 700 includes displaying a user interface item on a display. In some embodiments, a method such as method 200, described above, may be performed prior to step 702 to navigate a selection indicator to highlight a particular user interface item of choice.

At 704, method 700 includes receiving an audio signal from a wireless controller. The wireless controller may be a wireless microphone or other wireless controller, such as wireless controller 102 of FIG. 1. Typically, the method includes carrying out a selection operation on a user interface based on receiving both an audio signal and a position signal having defined characteristics or combinations of characteristics (e.g., both signals occur close in time and have relatively large magnitudes in comparison to surrounding portions of the signal stream). Accordingly, the audio signal of interest which is received at step 704 may be defined to include a peak, such as, for example, a peak within an audio signal stream received from the wireless controller. The audio signal stream may include signals corresponding to various sonic events, such as singing, spoken words, hand clapping, finger snapping, or any other such sonic event. One example criteria for recognizing a selection event may be recognizing or detecting a peak from one of these inputs. The audio signal may further include additional information for pitch detection, voice recognition, etc. such as a frequency components, amplitude components, etc. of the audio input. Accordingly, the selection event may be defined in terms of frequency characteristics of the audio input and/or the resulting audio signal.

At 706, method 700 includes receiving a position signal from a wireless controller. Such a step may be similar to that of step 204 described above with reference to FIG. 2. In some embodiments, the position signal may be an accelerometer output from an accelerometer of a wireless controller. As with the audio signal, the position signal of interest may be defined as having particular characteristics, such as a peak or other characteristic occurring within the stream of position signals.

At 708, method 700 includes recognizing a selection command based on the audio signal and the position signal. Such a selection command indicates a desired selection of the user interface item. In some embodiments, recognizing the selection command is defined by the audio signal and the position signal occurring relative to one another within a predetermined time interval. For example, a selection command may be recognized if the position signal of interest occurs within a few tenths of a second of the audio signal of interest. As an example, FIG. 8 shows a graph 800 of an audio signal stream over time including an audio signal 802, and a graph 804 of a position signal stream over time including a position signal 806. As shown, audio signal 802 and position signal 806 occur relative to one another within a time interval Δt, as shown at 808. A selection event may then be recognized, for example, if the time interval Δt is within a predetermined time interval.

Returning to FIG. 7, in some embodiments, recognizing the selection command may be defined by the audio signal having a peak that exceeds a threshold value. Additionally or alternatively, recognizing the selection command may be defined by the position signal having a peak that exceeds a threshold value.

At 710, method 700 includes selecting the user interface item in response to recognition of the selection command. Thus, in some embodiments, a computing system such as computing system 100 that is configured to execute instructions of method 700 may allow a user of the wireless controller to select items of a user interface displayed on the display simply by moving the wireless controller and making a noise. Thus, such selection may be independent of any physical button activation on the wireless controller. For example, a user may perform a motion of the wireless controller in a direction axial to the wireless controller, while tapping on the end of the microphone. Upon sensing the axial acceleration and the audio impulse from the tap, which would occur close in time as readily identifiable signals, the instructions would then execute a selection command of a user interface item.

In addition to the above navigation and selection operations, audio and/or position inputs may be used to provide other interactions with a user interface. It can be determined for example, that various physical motions applied to a wireless controller produce accelerometer signals having identifiable characteristics. These physical motions can then be mapped to various user interface operations. One example is the use of a long sweeping motion to cancel a selection item, or to step backward through a hierarchical menu sequence. More specifically, with reference to FIG. 1, if selection of one of the displayed user interface items of user interface 116 were to result in display of a sub-menu, the sweeping action detected by accelerometer 108 could be used to navigate back up to the original menu.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of selecting a user interface item via a wireless controller, the method comprising:
displaying the user interface item on a display;
receiving an audio signal from the wireless controller, the audio signal being based on an audio input detected by the wireless controller;
receiving a position signal from the wireless controller, the position signal being based on a position input detected by the wireless controller;
recognizing a selection command based on the audio signal and the position signal; and
selecting the user interface item in response to recognition of the selection command.

2. The method of claim 1, where the position signal is an accelerometer output of the wireless controller and where the audio signal is a microphone output of the wireless controller.

3. The method of claim 1, where the selection command is defined by at least one of the audio signal and the position signal including a peak that exceeds a threshold value.

4. The method of claim 1, where the selection command is defined by frequency characteristics of the audio signal.

5. The method of claim 1, where the selection command is defined by the audio signal and the position signal occurring relative to one another within a predetermined time interval.

6. A method of navigating a user interface via a wireless controller, the method comprising:
displaying a plurality of user interface items on a display;
receiving a first position signal from the wireless controller, the first position signal being based on a first position input detected by the wireless controller;
recognizing a navigation command based on the first position signal;
displaying on the display a navigation action in response to recognizing the navigation command, where the navigation action includes moving a selection indicator to highlight one of the plurality of user interface items;
receiving an audio signal from the wireless controller, the audio signal being based on an audio input detected by the wireless controller;
receiving a second position signal from the wireless controller, the second position signal being based on a second position input detected by the wireless controller;
recognizing a selection command based on the audio signal and the second position signal; and
selecting said one of the plurality of user interface items in response to recognition of the selection command.

7. The method of claim 6, where the first position signal is a first accelerometer output of the wireless controller and the second position signal is a second accelerometer output of the wireless controller.

8. The method of claim 7, where the first accelerometer output indicates a positioning of the wireless controller at an angle, and where the navigation action is a vertical scrolling action that is based on the angle.

9. The method of claim 8, where if the angle is within a first range of values the vertical scrolling action includes upward scrolling and where if the angle is within a second range of values the vertical scrolling action includes downward scrolling.

10. The method of claim 7, where the navigation action is a horizontal scrolling operation controlled in response to the first accelerometer output.

11. The method of claim 7, where the second accelerometer output indicates motion in a direction axial to the wireless controller.

12. The method of claim 6, where the audio signal includes a peak and where the selection command is defined by the peak exceeding a threshold value.

13. The method of claim 6, where the second position signal includes a peak and where the selection command is defined by the peak exceeding a threshold value.

14. The method of claim 6, where the selection command is defined by the audio signal and the second position signal occurring relative to one another within a predetermined time interval.

15. A computing system including:
a display device configured to display a user interface having a plurality of user interface items;
a wireless controller including an accelerometer configured to detect one or more position inputs indicating a position of the wireless controller and output the position inputs as one or more position signals, the wireless controller further configured to detect one or more audio inputs into the wireless controller and output the audio inputs as one or more audio signals; and
an interface module implemented via executable instructions on a data-holding subsystem, the interface module being operatively coupled with the display device and the wireless controller, and configured to:
recognize a navigation command based on a first position signal received from the wireless controller, and in response, to display on the display a navigation action, the navigation action moving a selection indicator to highlight one of the plurality of user interface items; and
recognize a selection command based on an audio signal received from the wireless controller and a second position signal received from the wireless controller, and in response, select said one of the plurality of user interface items.

16. The computing system of claim 15, where the accelerometer is a three-axis accelerometer and where the wireless controller has a form factor of a handheld microphone.

17. The computing system of claim 15, where the first position signal is based on a first position output indicating a positioning of the wireless controller at an angle, and where the navigation action is a vertical scrolling action that is based on the angle.

18. The computing system of claim 17, where if the angle is within a first range of values the vertical scrolling action includes upward scrolling and where if the angle is within a second range of values the vertical scrolling action includes downward scrolling.

19. The computing system of claim 15, where the second position signal is based on a second position output indicating motion in a direction axial to the wireless controller.

20. The computing system of claim 15, where the selection command is defined by the audio signal and the second position signal occurring relative to one another within a predetermined time interval.
